(19) United States
(12) Patent Application Publication
(10) Pub. No.: US 2021/0387446 A1
(43) Pub. Date: Dec. 16, 2021

(54) PAPER CONTAINER PACKAGE AND MANUFACTURING METHOD THEREFOR

(71) Applicant: Kai-Yu CHANG, Taichung City (TW)

(72) Inventor: Ching-Wen CHANG, Miaoli County (TW)

(21) Appl. No.: 17/277,113

(22) PCT Filed: Sep. 21, 2018
(86) PCT No.: PCT/CN2018/106853

§ 371 Date: Mar. 17, 2021

(51) Int. Cl. B32B 29/00; B32B 3/26; B32B 5/18; B32B 7/022; B65D 5/42; B65D 23/02; B65D 5/56; B31B 50/82

(52) U.S. Cl. CPC B32B 29/007; B31B 2105/001; B32B 5/18; B32B 7/022; B65D 5/4204; B65D 23/02; B65D 5/563; B31B 50/82; B32B 2307/732; B32B 2255/26; B32B 2255/12; B32B 2250/02; B32B 2266/0264; B32B 2266/0228; B32B 2266/025; B32B 2270/00; B32B 2439/00; B32B 3/266

(57) ABSTRACT

A paper container package is provided, including: a paper layer; two plastic layers disposed on two sides of the paper layer; wherein the two plastic layers and the paper layer define at least one window which is light-penetrable in a thickness direction of the paper layer. A method for manufacturing a paper container package is provided, including steps of: preparing a paper material; partially hollowing out a part of the paper material; disposing a plastic coating on an inner side of the paper material; disposing a plastic layer on an outer side of the paper material, to form a package material; cutting the package material to form at least one paper container package; wherein the part of the paper material which is partially hollowed out, the plastic layer and the plastic coating at least partially overlap in a thickness direction of the package material.

### BACKGROUND OF THE INVENTION

### Field of the Invention

The present invention relates to a paper container package and a manufacturing method therefor.

### Description of the Prior Art

Generally speaking, containers, such as bottles, paper containers, are mainly used for containing liquids.

The conventional paper container has a paper layer and a coating layer provided on the inner side of the paper layer, and the paper layer is folded and shaped into a predetermined shape and forms a containing room. The paper layer of the conventional paper container has a certain thickness to provide a supporting force. However, the paper layer is thick and difficult to shape, so the shape that the paper layer can be shaped into is limited. Moreover, if there is a need for observing the content(s) in the containing room, the conventional paper container should be partially hollowed out to form a window for observing the contents in the paper container, and an additional light-penetrable material must be attached to the inner side of the paper layer, which makes the processing cumbersome and difficult.

Furthermore, most of the conventional bottles are formed by plastic, which is not easy to print. Usually, another printed plastic sheet is disposed around the conventional bottle. Therefore, there is a big problem of printing on the conventional bottle.

The present invention is, therefore, arisen to obviate or at least mitigate the above-mentioned disadvantages.

### SUMMARY OF THE INVENTION

The main object of the present invention is to provide a paper container package and a manufacturing method therefor, in which at least one window is provided for observing an inside thereof.

To achieve the above and other objects, the present invention provides a paper container package.

Preferably, a part of the paper layer is partially hollowed out, and the two plastic layers cover the part of the paper layer which is partially hollowed out to form the at least one window.

Preferably, the two plastic layers are made of thermoplastic material.

Preferably, at least one of the two plastic layers is thicker than a thickness of the paper layer and is at least 1.5 times thicker than a thickness of the paper layer.

Preferably, at least one of the two plastic layers is at least 0.5 times thinner than a thickness of the paper layer.

Preferably, the paper container package includes a plurality of said windows.

Preferably, the rigidity of at least one of the two plastic layers is greater than the rigidity of the paper layer.

Preferably, the two plastic layers is partially melted to adhere to the paper layer; a part of the paper layer is partially hollowed out, and the two plastic layers cover the part of the paper layer which is partially hollowed out to form the at least one window; the two plastic layers are made of thermoplastic material; one of the two plastic layers has a thickness at least 1.5 times thicker than a thickness of the paper layer; the other of the two plastic layers has a thickness at least 0.5 times thinner than the thickness of the paper layer; the paper container package includes a plurality of said windows; one of the two plastic layers is made of polyethylene terephthalate, polystyrene, polyethylene, polylactic acid, or any combination thereof, and the other of the two plastic layers is made of low-density polyethylene, high-density polyethylene, polypropylene, polyethylene, polylactic acid, or any combination thereof.

Preferably, the paper container package further comprises a receiving room and an openable portion closing the receiving room, wherein the opening portion includes two connection pieces which are foldable and attached with each other.

Preferably, the paper container package further comprises a receiving room and an opening portion in communication with the receiving room, wherein the opening portion includes an external threaded structure configured for a cover detachably engaged therewith.

To achieve the above and other objects, the present invention further provides a method for manufacturing the paper container package, including: steps of: preparing a paper material; partially hollowing out a part of the paper material; disposing a plastic coating on an inner side of the paper material; disposing a plastic layer on an outer side of the paper material, to form a package material; cutting the package material to form at least one paper container package; wherein the part of the paper material which is partially hollowed out, the plastic layer and the plastic coating at least partially overlap in a thickness direction of the package material.

Preferably, the plastic layer is a plastic foam layer, and the plastic foam layer partially extends within the part of the paper material which is partially hollowed out, and the plastic foam layer is connected to the plastic layer.

Preferably, a plastic foam layer is covered on the plastic layer and partially overlaps the part of the paper material which is partially hollowed out.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIG. 2 is a cross-sectional view, taken along line A-A, of FIG. 1;

FIG. 3 is a cross-sectional view, taken along line B-B, of FIG. 1;

FIG. 4 is a perspective view of another preferred embodiment of the present invention;

FIG. 5 is a flowchart block diagram of a preferred embodiment of the present invention;

FIG. 6 is a manufacturing flowchart of a preferred embodiment of the present invention;

FIG. 7 is a schematic diagram of a package material according to a preferred embodiment of the present invention;

FIG. 8 is a perspective view of a paper container package according to another preferred embodiment of the present invention;

FIG. 9 is a partial cross-sectional view of FIG. 8; and

FIG. 10 is a partial cross-sectional view of another preferred embodiment of the present invention.

1, 2, 92: paper container package; 3: stamping mechanism; 4: squeezer; 5, 7: film; 6: roller; 8: cutting machine; 10: paper layer; 20, 30, 90: plastic layer; 40, 71: window 50: receiving room; 60: opening portion; 61: connection piece; 62: external threaded structure; S1-S5: steps; 70: paper material; 80: plastic coating; 91: package material; 93: plastic foam layer.

### DETAILED DESCRIPTION OF THE PREFERRED EMBODIMENTS

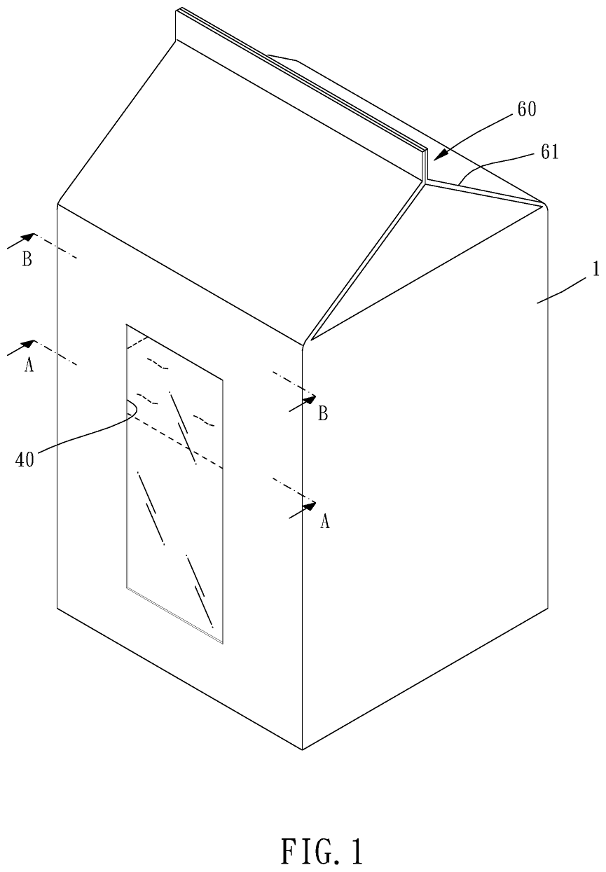

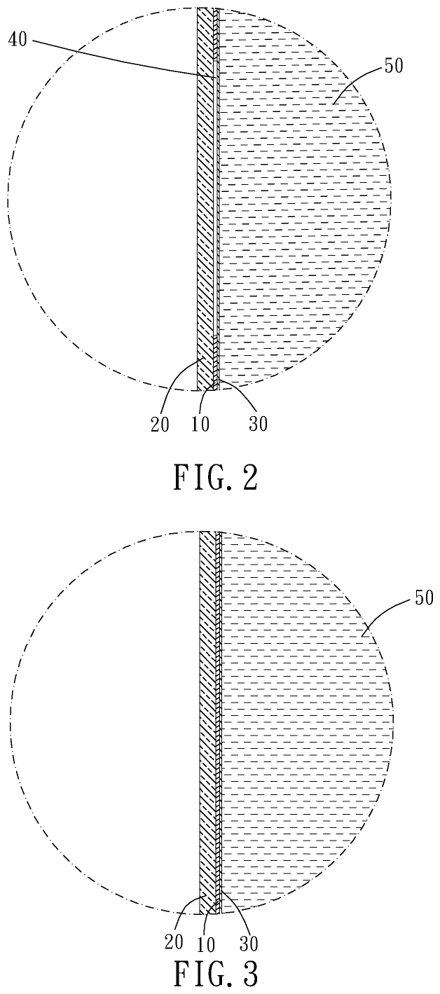

Please refer to FIGS. 1 to 3 for a preferable embodiment of the present invention. A paper container package 1 and manufacturing method therefor of the present invention includes a paper layer 10 and two plastic layers 20, 30.

The two plastic layers 20, 30 are disposed on two opposite sides of the paper layer 10. At least one of the two plastic layers 20, 30 is thicker than a thickness of the paper layer 10 and is at least 1.5 times thicker than a thickness of the paper layer 10. The two plastic layers 20, 30 and the paper layer 10 define at least one window 40 in a thickness direction of the paper layer 10, and the at least one window 40 is light-penetrable the window 40. Whereby, it is easy to make the window 40 and can print texts and/or patterns on the paper layer 10.

The paper container package preferably includes a plurality of said windows 40, and the plurality of said windows 40 may be rectangular, or may be of any shape or arranged in a linear or matrix arrangement. In this embodiment, a part of the paper layer is partially hollowed out, and the two plastic layers cover the part of the paper layer 10 which is partially hollowed out to form the at least one window 40. However, the paper layer 10 may include at least one region which may be hollowed out or light-penetrable solid portion corresponding to the at least one window 40.

At least one of the two plastic layers 20, 30 is made of thermoplastic material. In this embodiment, the two plastic layers 20, 30 are both made of thermoplastic material. The plastic layer 20 made of thermoplastic material may be shaped in a box shape (FIG. 1), bottle shape or any other configuration, and is of a rigidity greater than the rigidity of the paper layer 10, which provides good shape-retaining and water-proof characteristics. The two plastic layers 20, 30 may be partially melted to adhere to the paper layer 10.

Preferably, one of the two plastic layers 20, 30 is thicker than the paper layer 10, and the other of the two plastic layers 20, 30 is thinner than the paper layer 10. In this embodiment, the plastic layer 20 has a thickness at least 1.5 times thicker than a thickness of the paper layer 10, and the plastic layer 30 has a thickness at least 0.5 times thinner than the thickness of the paper layer 10. Each of the two plastic layers 20, 30 may be disposed on any side of the paper layer 10. In this embodiment, the plastic layer 20 is disposed on an outer side of a paper container, and the plastic layer 30 is disposed on an inner side of a paper container, wherein the plastic layer 20 which is thick can provide good resistance to external force onto the paper layer 20.

The plastic layer 20 is made of polyethylene terephthalate (PET), polystyrene (PS), polyethylene (PE), polylactic acid (PLA), or any combination thereof. The plastic layer 30 is made of low-density polyethylene, high-density polyethylene, polypropylene, polyethylene, polylactic acid, or any combination thereof.

The paper container package 1 further includes a receiving room 50 and an openable portion 60 closing the receiving room 50, and the opening portion 60 includes two connection pieces 61 which are foldable and attached with each other.

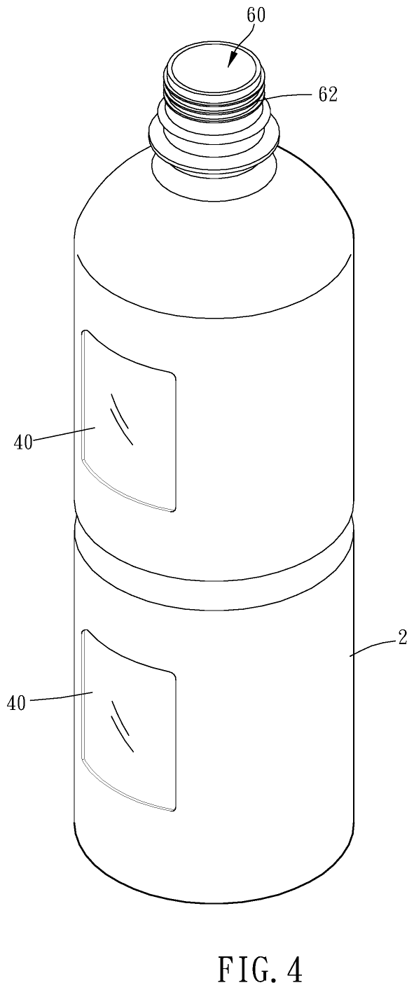

As shown in FIG. 4, in an alternative embodiment, the paper container package 2 includes an opening portion 60 in communication with the receiving room, and the opening portion 60 includes an external threaded structure 62 configured for a cover detachably engaged therewith.

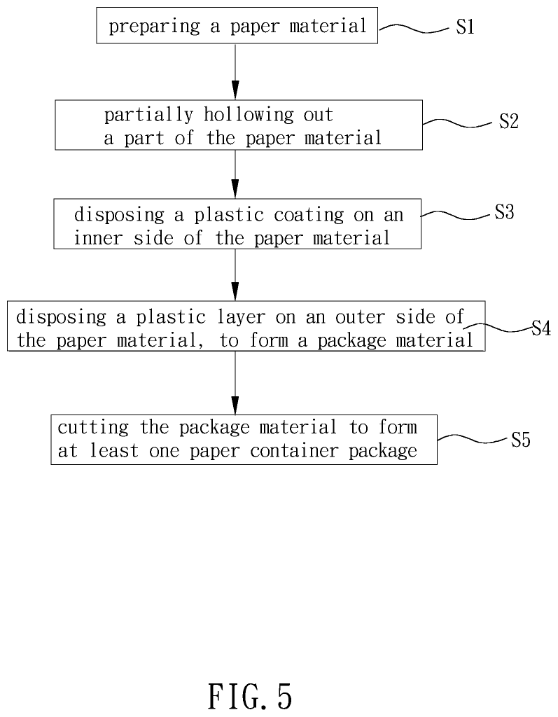

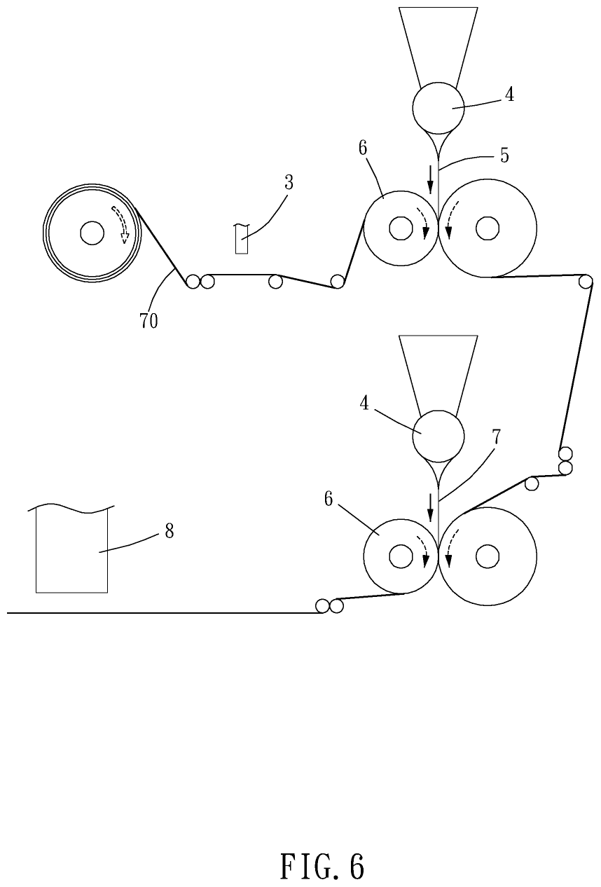

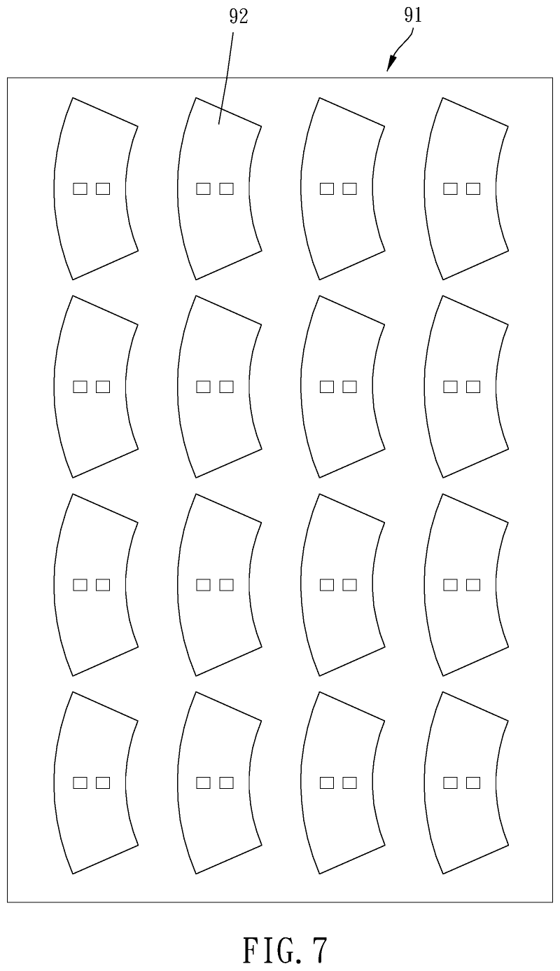

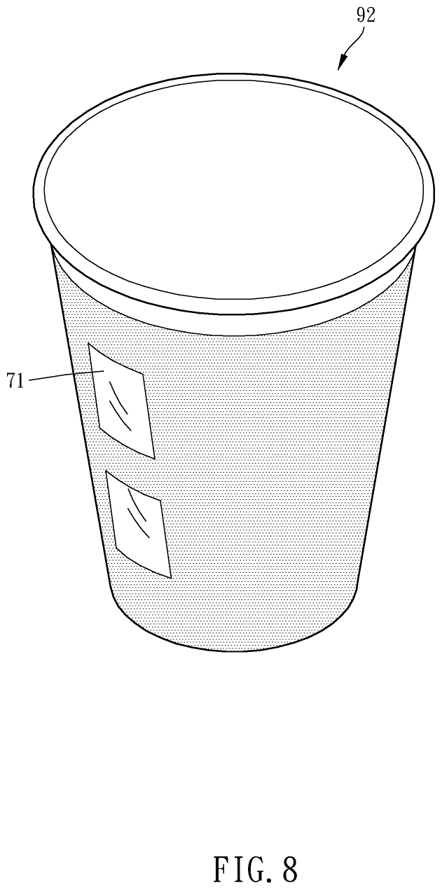

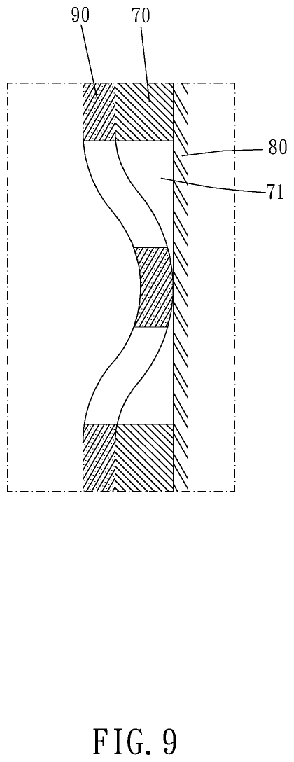

Please refer to FIGS. 5 to 9, a method for manufacturing a paper container package is provided, including steps of: step S1: preparing a paper material 70; step S2: partially hollowing out a part of the paper material 70, for forming a window 71 which may be formed by cutting or a stamping mechanism 3; step S3: disposing a plastic layer 80 on an inner side of the paper material 70 and squeezed under heating by a squeezer 4 and squeezed and cooled by rollers 6, to for a film 5, wherein the film 5 is the plastic coating 80 coated on the paper material 70; step S4: disposing a plastic layer 90 on an outer side of the paper material 70, to form a package material 91, wherein the plastic layer 90 may be a plastic coating or a plastic foam layer. In this embodiment, the plastic layer 90 is a plastic foam layer and squeezed under heating by a squeezer 4 and squeezed and cooled by rollers 6, to for a film 7, wherein the film 7 is the plastic layer 90 disposed on the paper material 70; step S5: cutting the package material 91 to form at least one paper container package 92 (a plurality of said paper container packages 92 in this embodiment), the plurality of said paper container packages 92 may be an annular body, box body or bottle body, wherein the package material 91 is cut by a cutting machine, and wherein the window 71, the plastic layer 90 and the plastic coating 80 at least partially overlap in a thickness direction of the package material 91. Whereby, the window 71 provides various visual effects and is good in heat isolation. It is noted that one of step S4 and step S5 may be carried out prior to the other of step S4 and step S5.

Specifically, the plastic foam layer may be formed by first coating plastic material containing foamable particles on the paper material 70, and then being heated to foam, such as being formed by hot press process. Preferably, the plastic foam layer partially extends within the window 71 and is connected to the plastic layer 90, which provides various visual effects to the window 71 and good structural strength in the thickness direction.

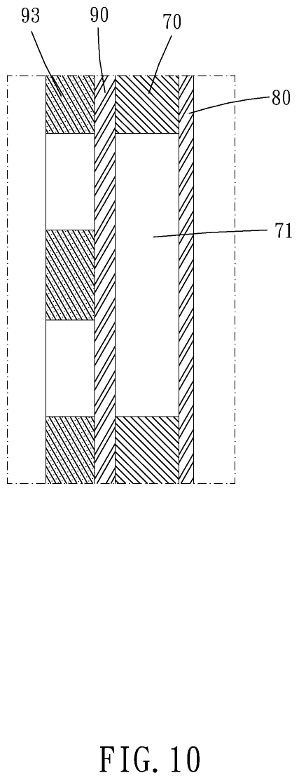

In another embodiment shown in FIG. 10, a plastic foam layer 91 is covered on the plastic layer 90 and partially overlaps the window 71, which is good in water-proof and heat isolation, and provides various visual effects.

It is noted that the plastic foam layer 93 may be colored and/or provided with bumpy, rugged, concave-convex structure or the like.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A paper container package, including:
a paper layer;
two plastic layers, disposed on two opposite sides of the paper layer;
wherein the two plastic layers and the paper layer define at least one window in a thickness direction of the paper layer, and the at least one window is light-penetrable.

2. The paper container package of claim 1, wherein a part of the paper layer is partially hollowed out, and the two plastic layers cover the part of the paper layer which is partially hollowed out to form the at least one window.

3. The paper container package of claim 1, wherein the two plastic layers are made of thermoplastic material.

4. The paper container package of claim 1, wherein at least one of the two plastic layers is thicker than a thickness of the paper layer and is at least 1.5 times thicker than a thickness of the paper layer.

5. The paper container package of claim 1, wherein at least one of the two plastic layers is at least 0.5 times thinner than a thickness of the paper layer.

6. The paper container package of claim 1, wherein the paper container package includes a plurality of said windows.

7. The paper container package of claim 1, wherein the rigidity of at least one of the two plastic layers is greater than the rigidity of the paper layer.

8. The paper container package of claim 7, wherein the two plastic layers is partially melted to adhere to the paper layer; a part of the paper layer is partially hollowed out, and the two plastic layers cover the part of the paper layer which is partially hollowed out to form the at least one window; the two plastic layers are made of thermoplastic material; one of the two plastic layers has a thickness at least 1.5 times thicker than a thickness of the paper layer; the other of the two plastic layers has a thickness at least 0.5 times thinner than the thickness of the paper layer; the paper container package includes a plurality of said windows; one of the two plastic layers is made of polyethylene terephthalate, polystyrene, polyethylene, polylactic acid, or any combination thereof, and the other of the two plastic layers is made of low-density polyethylene, high-density polyethylene, polypropylene, polyethylene, polylactic acid, or any combination thereof.

9. The paper container package of claim 1, further comprising a receiving room and an openable portion closing the receiving room, wherein the opening portion includes two connection pieces which are foldable and attached with each other.

10. The paper container package of claim 1, further comprising a receiving room and an opening portion in communication with the receiving room, wherein the opening portion includes an external threaded structure configured for a cover detachably engaged therewith.

11. A method for manufacturing a paper container package including steps of:
preparing a paper material;
partially hollowing out a part of the paper material;
disposing a plastic coating on an inner side of the paper material;
disposing a plastic layer on an outer side of the paper material, to form a package material;
cutting the package material to form at least one paper container package;
wherein the part of the paper material which is partially hollowed out, the plastic layer and the plastic coating at least partially overlap in a thickness direction of the package material.

12. The method of claim 11, wherein the plastic layer is a plastic foam layer, and the plastic foam layer partially extends within the part of the paper material which is partially hollowed out, and the plastic foam layer is connected to the plastic layer.

13. The method of claim 11, wherein a plastic foam layer is covered on the plastic layer and partially overlaps the part of the paper material which is partially hollowed out.
